(19) United States
(12) Patent Application Publication
(10) Pub. No.: US 2026/0178176 A1
(43) Pub. Date: Jun. 25, 2026

(54) ON-SCREEN MAGNIFIER FOR ACCESSIBILITY AT SELF-SERVICE TERMINALS (SSTs)

(71) Applicant: NCR Voyix Corporation, Atlanta, GA (US)

(72) Inventors: Kip Oliver Morgan, Atlanta, GA (US); John Kennedy, Lawrenceville, GA (US); Gina Torcivia Bennett, Lawrenceville, GA (US); Lauren Amelia Alderman LaRochelle, Atlanta, GA (US); Addison Sage Benson, Atlanta, GA (US); Jerry Steven Massey, Lawrenceville, GA (US); Erfan Khaki, Alpharetta, GA (US)

(21) Appl. No.: 18/990,637

(22) Filed: Dec. 20, 2024

(51) Int. Cl. G06F 3/04845; G06F 3/0482; G06Q 20/18

(52) U.S. Cl. CPC G06F 3/04845; G06F 3/0482; G06Q 20/18; G06F 2203/04806

(57) ABSTRACT

Methods and system for providing enhanced visual accessibility at self-service terminals (SSTs) through an improved user interface (UI) on-screen magnifier. The magnifier includes an extra-thick border for dragging from any edge and prevents the magnifier from being fully dragged off-screen. The magnifier's size and zoom level are configurable based on locale settings and language requirements. When activated through an accessibility menu of a transaction UI for a terminal, the magnifier initially appears centered on the screen and maintains native UI resolution scaling for magnified content. Usage metrics are captured to identify interface accessibility challenges and make user experience UI improvements. The magnifier's border thickness, lens size, and zoom level can be customized through configuration settings to accommodate different languages and regional preferences. Touch inputs are remapped at the application level to properly interact with magnified content. The magnifier is automatically deactivated upon transaction completion to prepare for subsequent users.

### BACKGROUND

Visually impaired individuals face significant challenges when attempting to use self-service kiosks and terminals. Current on-screen magnifiers present several usability problems that make it difficult for those with visual impairments to effectively interact with these systems. Specifically, activating magnification features is often challenging for visually impaired users to accomplish. When magnifiers are activated, users struggle with fundamental control functions—the zoom and resize controls can be hard to locate, moving the magnifier's position on the screen is cumbersome, and the viewable area is frequently insufficient for practical use.

Additionally, the grip areas provided for manipulating magnifiers tend to be too small or unintuitive to locate. A significant issue is that magnifier borders and edges typically blend into the regular screen, making it difficult for users to distinguish the boundaries of the magnified area. These accessibility challenges are further complicated by the fact that different regions and user populations may have varying requirements for magnification levels, grip sizes, and lens dimensions.

### BRIEF DESCRIPTION OF THE DRAWINGS

FIG. 1A is a diagram of a system for an on-screen magnifier for accessibility at self-service terminals (SSTs), according to an example embodiment.

FIG. 1B is a diagram depicting user interface (UI) screens to access accessibility UI elements and a UI magnifier widget, according to an example embodiment.

FIG. 1C is a diagram depicting a UI screen with the UI magnifier widget activated, according to an example embodiment.

FIG. 1D is a depiction of a heat map for usages of the UI magnifier widget with respect to UI elements of a UI screen, according to an example embodiment.

FIG. 2 is a flow diagram of a method for an on-screen magnifier for accessibility at an SST, according to an example embodiment.

FIG. 3 is a flow diagram of another method for an on-screen magnifier for accessibility at an SST, according to an example embodiment.

### DETAILED DESCRIPTION

Self-service terminals (SSTs) present significant accessibility barriers for visually impaired users attempting to complete transactions independently. Current magnification tools available on these terminals suffer from multiple usability shortcomings. The activation process for existing magnifiers proves particularly challenging for those with visual impairments to initiate. Once activated, users encounter difficulties with fundamental control mechanisms—the magnification controls are often obscured, repositioning the magnifier requires complex interactions, and the viewable area frequently proves inadequate for practical usage. The interfaces typically employ grip areas that are undersized or poorly indicated, making manipulation of the magnifier unnecessarily complex. Moreover, the boundaries between magnified and unmagnified areas lack clear delineation, creating confusion for users attempting to navigate the interface.

In an embodiment presented herein, a distinguishable button utilizing a specific configurable assistance color activates user interface (UI) accessibility features. Upon selection, users encounter an easy-to-read menu of accessibility options. When the UI magnifier option is selected, the presented magnifier incorporates an extra-thick border surrounding the magnifier, enabling users to drag the magnifier from any edge. This enhanced border serves multiple purposes—it clearly defines the magnifier boundaries while providing an intuitive grip area for repositioning the magnifier within a given transaction UI screen.

In an embodiment presented herein, the magnifier's dimensions and zoom capabilities are configurable based on localization requirements. For example, the magnifier's dimensions varies for text lengths across different languages by automatically adjusting the magnifier size based on localized store settings. Touch interactions are remapped at the application level, ensuring accurate response to user input through the magnified view.

In an embodiment, usage metrics are captured to identify interface challenges, enabling continuous refinement of the user experience and improvements to transaction UI interface screens for SSTs. These metrics include activation frequency, usage duration, UI screen locations accessed, and interaction patterns, which generate heat maps showing popular magnifier positions. This data helps identify screens that present particular challenges for visually impaired users, informing future interface improvements.

As used herein, the usage of the terms “user,” “operator,” and “customer,” and/or “consumer” may be used synonymously and interchangeably. That is, an individual who is performing a transaction at an SST and accessing an accessibility feature or option associated with providing a magnifier widget within the transaction UI screens during the transaction.

As used herein, the usage of “UI magnifier widget,” “magnifier widget,” and/or “magnifier” may be used synonymously and interchangeably. This is a set of software instructions are processed by a transaction interface and executed on a processor of an SST to provide a set of accessibility features to a user within a transaction screen of the transaction interface during a transaction. Example magnifier features, include magnification of text, images, and other UI elements, such as buttons, menus, scrolling, and data input entry fields. Some of the magnifier features are control features that permit the magnifier to be dragged and repositioned on the UI screen by touch interaction of a user and permit selection of a UI element magnified within the borders of the magnifier.

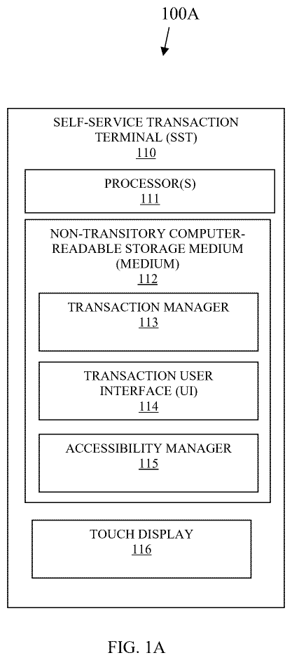

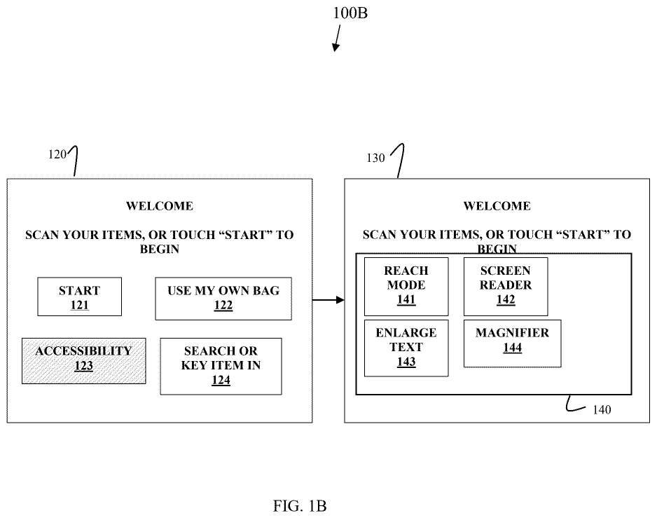

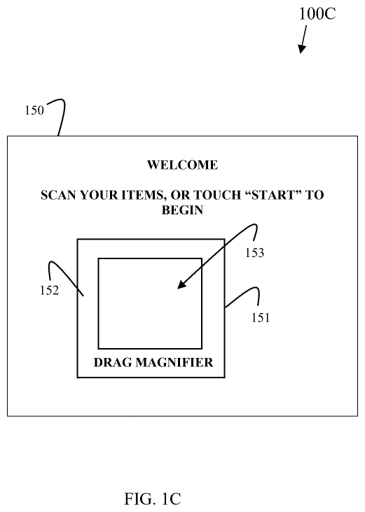

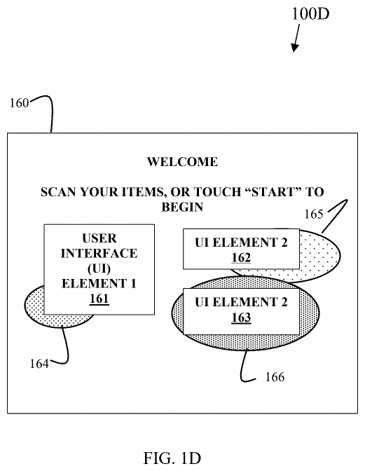

FIG. 1A is a diagram of a system 100A for an on-screen magnifier for accessibility at an SST, according to an example embodiment. Notably, the components are shown schematically in greatly simplified form, with only those components relevant to understanding of the embodiments being illustrated.

Furthermore, the various components (that are identified in system/platform 100A) are illustrated and the arrangement of the components are presented for purposes of illustration only. It is to be noted that other arrangements with more or less components are possible without departing from the teachings of providing an on-screen magnifier for accessibility at an SST, presented herein and below.

System 100A includes an SST 110. The SST 110 includes at least one processor 111 and a non-transitory computer-readable storage medium (medium) 112, which includes instructions for a transaction manager 113, a transaction UI 114, and an accessibility manager 115. The instructions when executed by the processor 111 cause the processor to perform operations discussed herein and below with respect to transaction manager 113, transaction UI 114, and accessibility manager 115. SST 110 also includes a touch display 116.

Notably, the SST 110 includes a variety of other peripheral devices which are not illustrated in FIG. 1A. For example, the SST 110 may include a card reader, a barcode scanner, a handheld scanner, a weigh scale, a combined barcode reader and weigh scale, a receipt printer, a currency acceptor, a currency dispenser, a bag well weigh scale, one or more wireless transceivers, a personal identification number (PIN) pad, and other peripherals.

Most conventional interfaces of SSTs include accessibility options for individuals that have disabilities and are unable to effectively operate the SSTs for self-checkouts. Once common accessibility feature is an on-screen magnifier used by visual impaired customers during self-service transactions at the SSTs. It is noted that there are a variety of other accessibility features for those that are hearing impaired, using a wheelchair, etc. Most governments mandate that retailers provide a minimum level of accessibility features to customers that are in need of them. In the case of conventional magnifiers, usability by customers with sight impairments is challenging as discussed at length above. These challenges are substantially mitigated by the teachings presented herein.

Transaction manager 113 is responsible for managing and processing a self-service transaction of a customer at SST 110. Transaction manager 113 processes and presents transaction UI 114 on interface screens presented on touch display 116. When a user selects a UI element associated with accessibility features for using the transaction UI 114 and corresponding interface screens during a transaction, accessibility manager 115 configures the transaction UI 114 to provide the user-selected accessibility features.

When a customer with a visual impairment approaches the SST 110 and needs to access an on-screen magnifier for the self-service transaction, they are presented with a welcome interface screen rendered by the transaction UI 114 as transaction manager 113 waits for a new transaction to be initiated. The customer initially needs to select the accessibility UI element from the welcome screen to activate a sub screen or superimposed screen that presents the customer with additional UI elements related to specific accessibility features. One of the selectable UI elements is for activating the magnifier for the transaction.

Unfortunately, some customers with sight impairments cannot easily find the accessibility UI element on the welcome screen because conventional UIs do make the accessibility UI element visually distinguishable or stand out from other available UI elements which the customer can also select from the welcome screen. To remedy this, the transaction UI 114 is configured to render the accessibility UI element in a distinguishable color that stands out from other available UI elements on the welcome screen. For example, the transaction UI 114 renders the accessibility UI element in a distinctive blue color. In an embodiment, the transaction UI also applies a visual effect to the accessibility UI element within the welcome screen to make it further stand out to the user. For example, the transaction UI 114 loops an animation such as a shimmer, a rotation, or a pulsing on the accessibility UI element so that the customer can clearly see and identify the accessibility UI element within the welcome screen.

After the customer selects the accessibility UI element, the transaction UI 114 renders a screen or sub screen superimposed on top of the welcome screen with specific accessibility UI elements from which the user can select from. When the customer selects the magnifier UI element, the accessibility manager 115 configures the transaction UI 114 to present a novel magnifier on subsequent screens rendered by the transaction UI 114 during the customer's self-service transaction at the SST 110.

Responsive to the configuration for the magnifier, transaction UI 114 renders the magnifier centered within the current screen being presented on the touch display 116 to the customer. The magnifier includes a very distinctive and oversized border. The border of the magnifier may also include a distinctive color such as orange. The size of the border and the color of the border can be defined in settings for a specific store. In an embodiment, the size of the border is a half inch or 44 pixels for a 96 dots per inch (dpi) display.

The customer can touch the border to grab and move the magnifier around the current screen presented on touch display. The portion inside the borders of the magnifier as it is moved presents enlarged or magnified text, images, or UI elements. The accessibility manager 115 configures the transaction UI 114 to provide a configured magnification or zoom level based on accessibility settings. In an embodiment, the configured magnification or zoom level is defined in the accessibility settings is a 2× magnification.

Accessibility manager 115 also configures the transaction UI 114 to present the magnifier with a default size within the current screen being rendered by the transaction UI. Again, this default size is configurable in the accessibility settings. In an embodiment, the default size of the magnifier is ⅖^{th} the size of the overall viewable area of the screen, or 40% of the viewable screen area.

The oversized and easy grabbed border is an improvement over conventional magnifiers that often require small buttons associated with the conventional magnifiers to move the conventional magnifier about a current screen. The customer can easily see, grab, drag, and move the magnifier presented herein about a current screen.

The oversized border surrounds all four sides of the magnifier and permits the transaction UI 114 to identifying when the customer is dragging the magnifier off the viewable area of the current screen. The transaction UI 114 uses the locations of all 4 sides of the border to maintain the magnifier within the viewable area of the current screen. In an embodiment, the transaction UI 114 maintains at least three sides of the border for the magnifier on the viewable area of the current screen at all times. For example, a customer can drag the magnifier to the far left of the viewable area of the screen and just the leftmost side of the border drops off the viewable area of the screen but the remaining three sides remaining completely within the viewable area of the screen. This ensures that the customer does not inadvertently move the magnifier off the viewable area of the screen during the transaction.

Conventional magnifiers often put on-screen zoom level and magnifier resizing buttons on the transaction screens. This makes things too complicated for visually impaired customers. Research has shown that while customers may prefer a larger magnifier or different zoom levels, this is often dependent upon the locale and community. As such, the magnifier presented herein is changed based on the accessibility settings, which are localized to the store, community, or region. However, in an optional embodiment, the magnifier a zoom slider along with a reset button is presented with the magnifier and is positioned at a top or a bottom of the viewing lens depending on the half of the screen that the magnifier is currently located in.

Furthermore, to ensure when customers touch the magnifier that they are actually touching the magnified data within the lens of the magnifier, customer touches are re-mapped at the application level to touch the magnified portion of the application that is beneath the lens. Touch responses and animations are also shown through the lens at their magnified level.

Some natural, written, and spoken languages, such as German, having many characters in their words such that a “drag magnifier” text label placed within the border of the magnifier need to be larger to accommodate the natural language being used by the transaction UI 114. The grip size of the border and the lens size for the magnifier can be set based on an accessibility setting associated with the natural language. Thus, the store can set the sizes that are needed for their store based on their native natural language.

Conventionally feedback about accessibility features from visually impaired customers is very limited. This situation is ameliorated with the teachings presented herein. The transaction UI 114 gathers usage data on how the magnifier is being used, such that insights can be obtained for how to optimize the magnifier for customers with sight impairments. The data gathered, includes by way of example only, how often the magnifier was enabled, how long it was enabled for each transaction, how often the customer requested help during each transaction. The size of the magnifier and the grip size (e.g., border width) are also recorded in records. Additionally, the x and y coordinate path for each transaction that utilizes the magnifier can be recorded. These paths are converted into heat maps showing popular positions with the transaction screens for the magnifier. A rendering of this data on top of the transaction screens can be used to provide data insights for screens that are the most challenging to use by the visually impaired. This also allows for screen designers to look for UI improvements in button sizes, text, color, and/or position of the UI elements, text, animations, and images. The capturing of magnifier usage metrics provides usage feedback data used to improve the magnifier and make UIs more accessible to the sight impaired. For example, if usage of the magnifier is low in a geographical area where it is not expected, a case study can be done to make sure the accessibility features can be made more usable in that region.

Gathering feedback on the magnifier helps to improve the features of the magnifier using the flexible parameters discussed above. This will make visually impaired customers more likely to come back to a retailer that has SST 110 because the customers appreciate having a thoughtful and independent customer experience during a self-service transaction.

The magnifier and its features put customers with sight impairments the at the forefront and prioritizes accessibility. As a result, the SST 110 not only easily meets current accessibility legal requirements but also becomes truly accessible for those who need it rather than a gimmick made to keep a given retailer out of lawsuits.

FIG. 1B is a diagram 100B depicting user interface (UI) screens 120 and 130 to access accessibility UI elements and a UI magnifier widget, according to an example embodiment. Initially, a customer with a sight impairment approaches SST 110 for a self-service transaction. Transaction UI 114 renders welcome screen 120 on the touch display 116.

Welcome screen 120 is rendered with a UI start button 121, a UI use my own bag button 122, and UI accessibility button 123, and a UI search or key item in button 124. The accessibility button 123 is rendered with a distinctive color and/or distinctive visual effects so that accessibility button 123 is readily and visibly discernible by the visually impaired customer.

When the customer selects the accessibility button 123, the transaction UI 114 renders a new version of screen 120 that includes a superimposed accessibility menu screen 140 superimposed overtop of original screen 120 as a new main screen 130. Within screen 140 the customer is presented with a reach mode button 141, a screen reader button 142, an enlarge text button 143 and a magnifier button 144. Assuming the customer selects the magnifier button from screen 140, a new screen is presented with the magnifier as discussed in FIG. 1C.

FIG. 1C is a diagram 100C depicting a UI screen 150 with the UI magnifier widget 151 (magnifier 151) activated, according to an example embodiment. Transaction UI 114 renders magnifier 151 within a current screen 150 during the transaction. The current screen 150 presented in FIG. 1C is a modified version of the welcome screen 120 since the customer selected the magnifier button 144 from accessibility menu screen 140 before the transaction started. However, it is noted that the customer has access to select the accessibility menu screen 140 from any screen rendered by the transaction UI 114 during the transaction.

The magnifier 151 is rendered and superimposed onto screen 150 with an oversized and enlarged border or border area 152. The bottom of the border area 152 includes a text label to indicate to the customer that the magnifier 151 is interactive and can be dragged about screen 150 through user touch on touch display 116. Inside of the border 152 is the magnifier's lens area 153, anything on screen 150 placed within the lens area 153 is magnified from the customer to view. Again, transaction UI 114 does not permit the customer to drag the magnifier 151 off the viewable area of screen 150; rather, and at most only the far right or far right side of the border 152 can be moved off the viewable area and at least three sides of the border 152 always remains within the viewable area of screen 150.

FIG. 1D is a depiction of a heat map 100D for usages of the UI magnifier widget 151 with respect to UI elements 161-163 of a UI screen 160, according to an example embodiment. The usage metrics of the magnifier 151 are superimposed onto a given screen 160 rendered by the transaction UI 114. The screen 160 includes known UI elements, such as UI element 1 161, UI element 2 162, and UI element 3 163. The usage metrics of the magnifier 151 with respect to the UI elements 161-163 are superimposed in color and/or patterns over the UI elements 161-163 to create a visual heat map. As was discussed above, this can be used to enable continuous improvement of magnifier 151, a layout of screen 160, and/or UI elements 161-163.

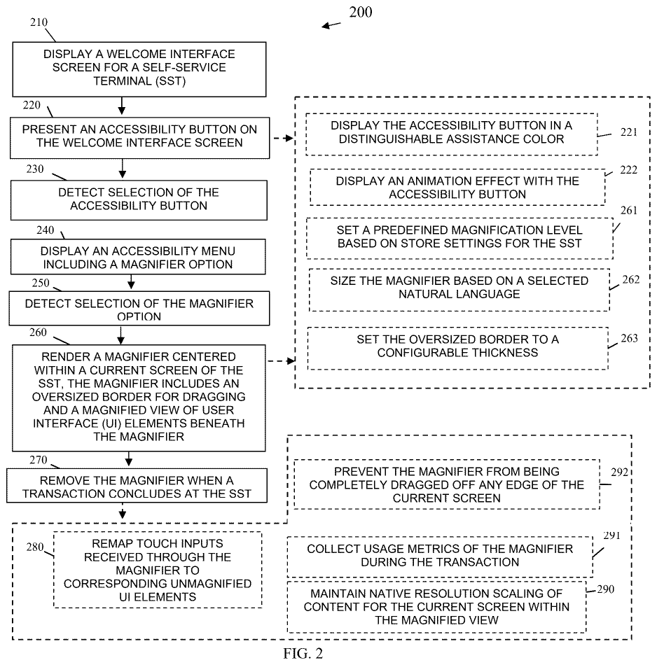

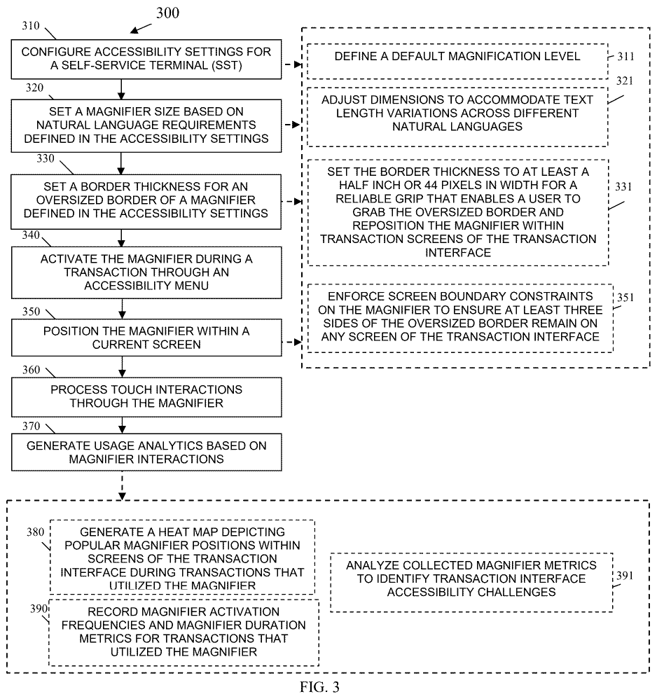

The above-referenced embodiments and other embodiments are now discussed within FIGS. 2-3. FIG. 2 is a flow diagram of a method 200 for an on-screen magnifier for accessibility at an SST, according to an example embodiment. The software module(s) that implements the method 200 is referred to as a “transaction interface.” The transaction interface is implemented as executable instructions programmed and residing within memory and/or a non-transitory computer-readable (processor-readable) storage medium and executed by one or more processors of one or more devices. The processor(s) of the device that executes the transaction interface are specifically configured and programmed to process the transaction interface The transaction interface may have access to one or more network connections during its processing. The network connections can be wired, wireless, or a combination of wired and wireless.

In an embodiment, the device that executes the transaction interface SST 110. In an embodiment, the SST 110 is a kiosk, an automated teller machine (ATM), or a self-checkout (SCO) terminal. In an embodiment, the transaction interface is all or some combination of transaction manager 113, transaction UI 114, and/or accessibility manager 115.

At 210, the transaction interface displays a welcome interface screen for an SST 110. The welcome interface screen is rendered to and presented on touch display 116 of SST 110.

At 220, the transaction interface presents an accessibility button on the welcome interface screen. In an embodiment, at 221, the transaction interface display the accessibility button in a distinguishable assistance color, which is configurable. In an embodiment, at 222, the transaction interface displays an animation effect with the accessibility button; this may be in addition to the distinguishable assistance color.

At 230, the transaction interface detects a selection of the accessibility button. The selection can be made from the welcome interface screen or from any current screen being rendered by the transaction interface to the touch display 116 of SST 110.

At 240, the transaction interface displays an accessibility menu or accessibility menu screen based on the selection at 230. The accessibility menu at least includes a magnifier option.

At 250, the transaction interface detects a selection of the magnifier option. At 260, the transaction interface renders a magnifier centered within a current screen of the SST 110. The magnifier includes an oversized border for dragging a magnified view of UI elements beneath the magnifier or within the lens of the magnifier.

In an embodiment, at 261, the transaction interface sets a predefined magnification level or zoom level based on store settings for the SST 110. In an embodiment, at 262, the transaction interface sizes the magnifier based on a selected natural language. In an embodiment, at 263, the transaction interface sets the oversized border to a configurable thickness.

At 270, the transaction interface removes the magnifier when a transaction concludes at the SST. During the transaction, the magnifier remains on any screen rendered by the transaction interface unless deactivated by a customer associated with the transaction.

In an embodiment, at 280, the transaction interface remaps touch inputs received through the magnifier to corresponding unmagnified UI elements. Transaction interface communicates selections or input associated with the unmagnified UI elements to the transaction manager 113 which processes the transaction.

In an embodiment, at 290, the transaction interface maintains native resolution scaling of content for the current screen within the magnified view. That is, if the unmagnified resolution of the current screen is X, any content being magnified within the lens of magnifier on the current screen is scaled such that it is also at a resolution of X.

In an embodiment, at 291, the transaction interface collects usage metrics of the magnifier during the transaction. The usage metrics are maintained with other usage metrics that utilized the magnifier during other transactions at the SST 110. In an embodiment, at 292, the transaction interface prevents the magnifier from being completely dragged off any edge of the current screen.

FIG. 3 is a diagram of another method 300 for an on-screen magnifier for accessibility at an SST, according to an example embodiment. The software module(s) that implements the method 300 is referred to as an “accessibility interface manager.” The accessibility interface manager is implemented as executable instructions programmed and residing within memory and/or a non-transitory computer-readable (processor-readable) storage medium and executed by one or more processors of a device. The processors that execute the accessibility interface manager are specifically configured and programmed for processing accessibility interface manager. The accessibility interface manager may have access to one or more network connections during its processing. The network connections can be wired, wireless, or a combination of wired and wireless.

In an embodiment, the device that executes the accessibility interface manager is SST 110. In an embodiment, the SST 110 is a kiosk, an ATM, or an SCO terminal. In an embodiment, the accessibility interface manager is all or some combination of transaction manager 113, transaction UI 114, accessibility manager 115, and/or method 200. The accessibility interface manager presents another and, in some ways, an enhanced processing perspective from that which was discussed above with method 200.

At 310, the accessibility interface manager configures accessibility settings for an SST 110. In an embodiment, at 311, the accessibility interface manager defines a default magnification level or zoom level based on the accessibility settings.

At 320, the accessibility interface manager sets a magnifier size based on natural language requirements defined in the accessibility settings. In an embodiment, at 321, the accessibility interface manager adjust dimensions to accommodate text length variations across different natural languages.

At 330, the accessibility interface manager sets a border thickness from an oversized border of a magnifier defined in the accessibility settings. In an embodiment, at 331, the accessibility interface manager sets the border thickness to at least a half inch or 44 pixels in width on a 96 dots per inch (dpi) display for a reliable grip that enables a user to grab the oversized border and reposition the magnifier within transaction screens of the transaction UI 114.

At 340, the accessibility interface manager activates the magnifier during a transaction through an accessibility menu. At 350, the accessibility interface manager positions the magnifier within a current screen based on user interaction with the magnifier. In an embodiment, at 351, the accessibility interface manager enforces screen boundary constraints on the magnifier to ensure at least three sized of the oversized border remain on any screen of the transaction UI 114.

At 360, the accessibility interface manager processes touch interactions through the magnifier. At 370, the accessibility interface manager generates usage analytics based on magnifier interactions.

In an embodiment, at 380, the accessibility interface manager generates a heat map depicting popular magnifier positions within screens of the transaction UI 114 during transactions that utilized the magnifier. In an embodiment, at 390, the accessibility interface manager record magnifier activation frequencies and magnifier duration metrics for transactions that utilized the magnifier. In an embodiment, at 391, the accessibility interface manager analyze collected magnifier metrics to identify transaction UI accessibility challenges.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
displaying a welcome interface screen for a self-service terminal (SST);
presenting an accessibility button on the welcome interface screen;
detecting selection of the accessibility button;
displaying an accessibility menu comprising a magnifier option;
detecting selection of the magnifier option;
rendering a magnifier centered within a current screen of the SST, wherein the magnifier comprises an oversized border for dragging and a magnified view of user interface (UI) elements beneath the magnifier; and
removing the magnifier when a transaction concludes at the SST.

2. The method of claim 1, wherein presenting further comprises displaying the accessibility button in a distinguishable assistance color.

3. The method of claim 1, wherein presenting further comprises displaying an animation effect with the accessibility button.

4. The method of claim 1, wherein rendering further comprises setting a predefined magnification level based on store settings for the SST.

5. The method of claim 1, wherein rendering further comprises sizing the magnifier based on a selected natural language.

6. The method of claim 1. wherein rendering further comprises setting the oversized border to a configurable thickness.

7. The method of claim 1, wherein rendering further comprises preventing the magnifier from being completely dragged off any edge of the current screen.

8. The method of claim 1 further comprising:
remapping touch inputs received through the magnifier to corresponding unmagnified UI elements.

9. The method of claim 1 further comprising:
maintaining native resolution scaling of content for the current screen within the magnified view.

10. The method of claim 1 further comprising:
collecting usage metrics of the magnifier during the transaction.

11. A method, comprising:
configuring accessibility settings for a self-service terminal (SST);
setting a magnifier size based on a natural language requirement defined in the accessibility settings;
setting a border thickness for an oversized border of a magnifier defined in the accessibility settings;
activating the magnifier during a transaction through an accessibility menu;
positioning the magnifier within a current screen;
processing touch interactions through the magnifier; and
generating usage analytics based on magnifier interactions.

12. The method of claim 11, wherein configuring further comprises defining a default magnification level.

13. The method of claim 11, wherein setting the magnifier size further comprises adjusting dimensions to accommodate text length variations across different natural languages.

14. The method of claim 11, wherein setting the border thickness further comprises setting the border thickness to at least a half inch or 44 pixels in width for a reliable grip that enables a user to grab the oversized border and reposition the magnifier within transaction screens of a transaction interface.

15. The method of claim 11, wherein positioning further comprises enforcing screen boundary constraints on the magnifier to ensure at least three sides of the oversized border remain on any screen of a transaction interface.

16. The method of claim 11 further comprising:
generating a heat map depicting popular magnifier positions within screens of a transaction interface during transactions that utilized the magnifier.

17. The method of claim 11 further comprising:
recording magnifier activation frequencies and magnifier duration metrics for transactions that utilized the magnifier.

18. The method of claim 11, further comprising:
analyzing collected magnifier metrics to identify transaction interface accessibility challenges.

19. A system, comprising:
a self-service terminal (SST) comprising a display; a processor; and
a non-transitory computer-readable storage medium having instructions executable by the processor to:
present an accessibility interface comprising a magnifier option;
render a magnifier with a configurable oversized border;
process touch inputs through the magnifier;
maintain screen boundary constraints during magnifier movement; and
collect usage analytics for the magnifier.

20. The system of claim 19, wherein the instructions are further executable to adjust magnifier dimensions based on interface language settings and maintain native resolution scaling within the magnifier.
